(19) United States
(12) Patent Application Publication
(10) Pub. No.: US 2005/0271796 A1
(43) Pub. Date: Dec. 8, 2005

(54) Thin-film electrochemical devices on fibrous or ribbon-like substrates and method for their manufacture and design

(76) Inventors: Bernd J. Neudecker, Littleton, CO (US); Bruce Lanning, Littleton, CO (US); Joseph H. Armstrong, Littleton, CO (US); Martin H. Benson, Littleton, CO (US); Brian K. Emerson, Littleton, CO (US)

Correspondence Address: LATHROP & GAGE LC, 4845 PEARL EAST CIRCLE, SUITE 300, BOULDER, CO, 80301, US

(21) Appl. No.: 10/893,664

(22) Filed: Jul. 16, 2004

Related U.S. Application Data
(62) Division of application No. 10/238,606, filed on Sep. 11, 2002.
(60) Provisional application No. 60/318,321, filed on Sep. 12, 2001.

(51) Int. Cl. B05D 5/12

(52) U.S. Cl. 427/58; 427/256; 427/282; 29/623.5

(57) ABSTRACT

The fabrication of functional thin-film patterns, such as solid-state thin-film batteries on substrates having fibrous, or ribbon-like or strip-like geometry is disclosed. The present invention relates additionally to the design and manufacture of multiple-layer and multi-function thin films.

### CROSS REFERENCE TO RELATED APPLICATIONS

This patent application is a divisional of commonly-owned and copending U.S. patent application Ser. No. 10/238,606 (filed Sep. 11, 2002), which is incorporated herein by reference and claims the benefit of, under 35 U.S.C. § 119(e), U.S. Provisional Patent Application Ser. No. 60/318,321, filed 12 Sep. 2001, which is also expressly incorporated fully herein by reference.

### STATEMENT REGARDING FEDERALLY SPONSORED RESEARCH OR DEVELOPMENT

This invention may have been made with Government support under Contract No. N00014-00-C-0479 awarded by the Office of Naval Research. The Government may have certain rights in this invention.

### BACKGROUND OF THE INVENTION

1. Field of the Invention

The present invention relates to the fabrication of functional thin-film patterns, such as solid-state thin-film batteries on substrates having fibrous, ribbon-like, or strip-like geometry. The present invention relates additionally to the design and manufacture of multiple-layer and multi-function thin films.

2. Description of the Art

Traditionally, solid-state thin-film batteries have been made on rigid planar substrates. Thus, the overall properties of multilayer materials have been limited by the rigidity and physical properties of the substrate. Because the present invention relates to, for example, creating multilayer materials by means of shadow masking a vacuum coating process on a fibrous substrate, the technology may relate to two general categories: shadow masking of multilayer and multifunctional thin-film coatings and vacuum coating of fibrous monofilament substrates.

A technique that has been widely used in the vacuum thin film industry to selectively deposit sequential or multilayer thin films in specific patterns is to apply a physical constraint to the vapor or plasma to prevent the vapor or plasma from reaching areas not targeted for deposition. The types of masks generally used include fabricated metal, glass, and ceramics, as well as photoresist patterned masking. The primary applications of these technologies have been restricted to planar substrate geometries. Examples of thin-film product areas utilizing physical shadow masks include thin-film batteries, electronic integrated microcircuits, circuit boards, diode arrays, and electroluminescent and semiconductor devices. Examples of these products may be found in, for example, U.S. Pat. Nos. 4,952,420; 6,214,631; 4,915,057; 6,218,049; 5,567,210; 5,338,625; 6,168,884; 5,445,906; 5,512,147; 5,552,242; 5,411,592; 5,171,413; 5,961,672; 5,110,696; and 4,555,456; and international patents and patent applications numbers WO 9930336; WO 9847196; WO 0060682; WO 0117052; JP 60068558; and DE 19850424.

Additionally, sequential shadow masking to produce patterned multilayer thin films has been explored. For example, in thin-film battery designs, metal templates or shadow masks have been used to control the deposition of battery films in specific geometries to perform specific functions. Some of these functions include cathode-to-anode pairing, electrolyte separation, and current collector masking. These examples of planar configuration shadow masking may be seen, for example, in U.S. Pat. Nos. 6,218,049; 5,567,210; 5,338,625; 6,168,884; 5,445,906; 4,952,420; 6,214,631; and 4,915,057; and international patents or patent applications numbers WO 9847196; WO 9930336; and DE 19850424. Additionally, some examples of shadow masking on fiber substrates include European patent application number EP 1030197 and U.S. Pat. Nos. 5,308,656 and 6,066,361.

Examples of photoresist masking for patterning vacuum deposited thin films may be seen, for example, in U.S. Pat. Nos. 6,093,973; 6,063,547; 5,641,612; 6,066,361; and 5,273,622; and in international patents or patent applications numbers GB 2320135 and EP 1100120.

Vacuum thin-film coatings have been extensively used in, for example, fiber-reinforced composite materials, superconducting fibers and wires, as well as optical fiber applications. Largely, research in vacuum coated fibers has been confined to continuous substrate deposition. Some examples of continuous fiber coating apparatuses are U.S. Pat. Nos. 5,518,597; 5,178,743; 4,530,750; 5,273,622; 4,863,576; and 5,228,963; and international patents or patent applications numbers WO 0056949; RU 2121464; and EP 0455408. Some examples of composite material fiber coating include U.S. Pat. Nos. 5,426,000; 5,378,500; and 5,354,615; and international patents or patent application numbers EP 0423946, and GB 2279667. Some examples of optical fiber coating include U.S. Pat. Nos. 5,717,808; 4,726,319; 5,320,659; and 5,346,520, and European patent application number EP 0419882. Some examples of superconducting wire and fiber coatings include U.S. Pat. Nos. 6,154,599; 5,140,004; and 5,079,218 and European patent application number EP 0290127.

Batteries on fibrous substrates have been discussed in the art. For example, at least one company has a battery that is formed with only one electrode per substrate. Other examples of batteries or other functional patterns on substrates include U.S. Pat. Nos. 6,004,691; 5,989,300; 5,928,808; 5,916,514; 5,492,782 and 5,270,485.

### SUMMARY OF THE INVENTION

The present invention attempts to solve the limitations described above. In particular, the present invention relates to patterned thin-film electrochemical devices such as batteries on, for example, flexible, fibrous, or ribbon-like substrates, and to the design and manufacture of the same. The present invention relates additionally to the design and manufacture of multiple-layer and multi-function thin films. A design of the present invention may be observed in an embodiment in which a thin-film battery is deposited, for example, selectively or sequentially, on or along the length of a substrate by use, for example, of a movable shadow mask, and the substrate shape may be controlled, for example, by means of a movable shadow mask. The shadow mask may, for example, be a sleeve or hollow tube through which the substrate may be threaded. Herein a preferred method for shadow masking is accomplished by means of a tubular member in which the substrate is preferably non-contactively disposed (for example, threaded in such a way as that it does not touch the mask). Although in planar geometries shadow masks are generally two-dimensional templates, in the cylindrical geometry associated with a fibrous or ribbon-like substrate, it may be helpful to use a shadow mask that is a hollow cylinder.

The substrate may also perform a secondary purpose. For example, the substrate may be or include an optical fiber. The invention may produce thin-film devices that are flexible, thus allowing use in a wider variety of applications. Moreover, the methods of deposition disclosed herein permit the deposition of thin-film devices on substrates which are not required to meet strict rigidity limitations. The present invention discloses a method that permits the deposition of systematically patterned multilayer thin-film devices. Certain embodiments of the present invention include synthetic multi-functional materials such as thin-film batteries on optical fiber, super-conducting, or shape memory substrates. These resultant multifunctional materials may have a wide array of uses including, for example, battery-amplified waveguides and optical fibers, power-generating fabrics, micro-airborne vehicles, and firearms.

One embodiment of the present invention, for example, overcomes the problems of planar geometric requirements by permitting thin-film functional patterns to be deposited on fibrous substrates. These embodiments may take the form, for example, of flexible power sources, battery-amplified waveguides and optical fibers, freestanding self-powered high-frequency generators, transmitters and receivers, battery antenna hybrids, or battery induction coil hybrids. Another embodiment of the present invention, for example, overcomes the problem of providing contacts in multilayer electrical devices deposited on fibrous or ribbon-like substrate through a method of patterned deposition that allows selective deposition, thereby leaving some portions of underlying layers in a multilayer pattern exposed.

Another problem, for example, that certain embodiments of the present invention overcome is the problem of providing flexible thin-film lithium-based batteries. This is accomplished, for example, by providing a method for manufacturing solid-state thin-film lithium-based batteries on flexible substrates including fibrous, ribbon-like, and strip-like substrates. The method of manufacture may permit one or more batteries to be deposited on a single substrate.

In a preferred embodiment, the present invention may relate to a method for depositing thin films on a fibrous or ribbon-like substrate by providing the fibrous or ribbonlike substrate, depositing functional layers on portions of the fibrous or ribbon-like substrate, and defining these portions by positioning an indexed tubular member. A method of shadow masking a fibrous substrate and an apparatus for accomplishing this technique are described in U.S. patent application Ser. No. 10/109,991, which is incorporated herein by reference in its entirety. A technique for shadow masking may be exemplified in an embodiment in which the functional pattern is a thin-film battery applied by a deposition process while using a shadow mask. The shape of each layer of the pattern may, in this instance, be controlled by means of a shadow mask. The shadow mask may, for example, be a sleeve or hollow tube through which the substrate may be threaded. A preferred method for shadow masking is accomplished by means of a tubular member in which the substrate is preferably non-contactively disposed, for example, threaded in such a way that it does not touch the mask. Although in planar geometries shadow masks are generally two-dimensional templates, in the cylindrical geometry associated with a fibrous or ribbon-like substrate, it may be helpful to use a shadow mask that is a hollow cylinder.

In a further preferred embodiment, the functional layers may include one or more of the following layers: anode current collector layers, anode layers, electrolyte layers, cathode layers, cathode current collector layers, overlayers, photoactive layers, n-type window layers, p-type absorber layers, transparent conductive layers, electrically conductive layers, metallic layers, semiconductor layers, optically transmitive layers, thermally insulating layers, thermally conductive layers, weatherproofing layers, cell contact layers, via layers, bus layers, printed circuit layers, sheath layers, lubricating layers, colored layers, grip layers, buffer layers, and auxiliary layers.

In a specific embodiment, the functional layers may be selected to result in a battery configuration with an exposed anode. In an alternate embodiment, the functional layers may be selected to result in a battery configuration with a buried anode.

In further embodiments, the functional layers may be selected to result in lithium-based battery configurations, sodium based battery configurations, or proton based battery configurations.

In a preferred embodiment, the present invention may relate to an apparatus used as a functional thin-film pattern on a fibrous or ribbon-like substrate including a fibrous or ribbon-like substrate and functional layers on portions of the fibrous or ribbon-like substrate. The portions of the substrate upon which the layers may be deposited may be selected based on the desired function of the thin-film pattern. In a specific embodiment, the portions may define an electrochemical cell. In a preferred embodiment, the electrochemical cell may include a device chosen from a group consisting of a lithium anode battery, a buried lithium anode battery, a lithium-ion anode battery, a buried lithium-ion anode battery, a lithium-free anode battery, a buried lithium-free anode battery, a nickel metal hydride configuration, a nickel cadmium configuration, and a copper-indium-gallium-selenide photovoltaic device.

In a specific embodiment of the present invention, the substrate may be or include a fiber. In a preferred embodiment, a cross-section perpendicular to the fiber's length may be circular or elliptical.

In a specific embodiment, two groups each including portions of the substrate may be selected such that the first group and the second group do not overlap. In this specific embodiment, the first group may define a first device, and the second group may define a second device. In a preferred embodiment, each of the first and second devices may include a device chosen from the group consisting of a lithium anode battery, a buried lithium anode battery, a lithium-ion anode battery, a buried lithium-ion anode battery, a lithium-free anode battery, a buried lithium-free anode battery, a nickel metal hydride configuration, a nickel cadmium configuration, and a copper-indium-gallium-selenide photovoltaic device. In a preferred embodiment, the first device may be the same type as the second device. In another preferred embodiment of the present invention, the first device may complement the second device. For instance, the first device may produce charge, and the second device may store charge.

It is an object of the present invention to provide a non-contact method of patterning thin-film multilayer depositions on fibrous and ribbon-like substrates.

It is an object of the present invention to provide a method for the tailorable production of thin-film functional patterns on fibrous or ribbon-like substrates.

It is an object of the present invention to provide thin-film batteries that may be incorporated into complex multi-substrate structures, such as, for example, a woven freestanding structure, a woven structure within a rubber, bismaleimide, or silicone matrix, or a non-woven structure in a matrix. This combination of multiple substrates may have the beneficial property of increasing either the total voltage (if the batteries are connected in series) or total capacity (if the batteries are connected in parallel).

It is an object of the present invention to provide a thin-film battery that has an optimized gravimetric and volumetric power and capacity density by minimizing the substrate cross-section. In an embodiment in which the substrate has no sharp edges, the entire substrate surface may be homogeneously utilized.

An advantage provided by the present invention is the degree of choice in substrate selection provided. Particularly, substrates over a wide range of flexibility may be used, thereby contributing to overall device (when, for example, the patterned functional thin film are a device) flexibility, which may be desirable in certain applications. Applications of fibrous substrates in multifunctional materials are described in U.S. Provisional Patent Application 60/318,319, which is incorporated herein by reference in its entirety.

It is understood that both the foregoing general description and the following detailed description are exemplary and explanatory only and are not restrictive of the invention as claimed. The invention is described in terms of a thin-film electrochemical device on fibrous or ribbon-like substrates, however, one skilled in the art will recognize other uses for the invention. For example, the invention may be used in the art of pyrotechnics and explosives, by selecting a substrate that is or includes a fuse. In this embodiment, the subsequently applied layers would not usually be applied by a plasma spray, and may, for example, be applied in a spray of an aqueous solution or tincture. Similarly, in the art of confection, for example, an edible or non-poisonous (for example, wood or plastic) substrate may be used. In this embodiment, for example, superheated or similarly vaporized or atomized layers of confection (including, for example, nougat, caramel, or sugar) may be sprayed or otherwise deposited onto the substrate by means of the method or apparatus of the present invention. The accompanying drawings illustrating an embodiment of the invention and together with the description serve to explain the principles of the invention.

### BRIEF DESCRIPTION OF THE DRAWINGS

FIG. 1 is a perspective view cut-away diagram of an example of a thin-film lithium battery on a fibrous substrate.

FIG. 2 is a stylized depiction of the operation of a discrete deposition indexing method.

FIG. 3A is a side-view depiction of an embodiment of a solid-state thin-film battery.

FIG. 3B is a side-view depiction of an embodiment of a solid-state thin-film battery.

FIG. 4 depicts the capacity measured in microampere-hours of a battery manufactured according to the present invention over 200 power cycles.

FIG. 5A is a cross-sectional view of an embodiment of the present invention.

FIG. 5B is a cross-sectional view of an embodiment of the present invention.

FIG. 5C is a cross-sectional view of an embodiment of the present invention.

FIG. 6 is a length-wise cutaway diagram of a CIGS photovoltaic device configuration.

FIG. 7 is a length-wise cutaway diagram of a lithium-free battery configuration.

FIG. 8 is a length-wise cutaway diagram of a buried lithium-free battery configuration.

FIG. 9 is a length-wise cutaway diagram of a lithium-ion battery configuration.

FIG. 10 is a length-wise cutaway diagram of a micro-electronic interconnect configuration.

FIG. 11A is the first stage of a working mechanism diagram of a lithium-free battery configuration.

FIG. 11 B is the second stage of a working mechanism diagram of a lithium-free battery configuration.

FIG. 12A is the first stage of a working mechanism diagram of a buried lithium-free battery configuration.

FIG. 12B is the second stage of a working mechanism diagram of a buried lithium-free battery configuration.

FIG. 13A is the first stage of a working mechanism diagram of a lithium-ion battery configuration.

FIG. 13B is the second stage of a working mechanism diagram of a lithium-ion battery configuration.

FIG. 14 is a a side view of a twisted embodiment of the present invention employing a single device on a substrate.

FIG. 15 is a perspective view of a twisted embodiment of the present invention employing three devices on a single substrate.

FIG. 16 is a depiction of multiple embodiments of the present invention connected together.

FIG. 17 is a diagram of the performance of an embodiment of the present invention in terms of discharge capacity in microampere-hours with respect to number of charge-discharge cycles.

FIG. 18 is a diagram of the performance of an embodiment of the present invention in terms of voltage with respect to discharge capacity measured in microampere-hours.

### DETAILED DESCRIPTION OF THE INVENTION

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a layer” is a reference to one or more layers and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. The invention is described in terms of thin-film deposition on fibrous or ribbon-like substrates; however, one of ordinary skill in the art will recognize other applications for this invention including, for example, applications in confectionery sciences and pyrotechnics.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. All references cited herein are incorporated by reference herein in their entirety.

For convenience, the meaning of certain terms and phrases employed in the specification, examples, and appended claims are provided below. The definitions are not meant to be limiting in nature yet serve to provide a clearer understanding of certain aspects of the present invention.

The phrase fibrous substrate means a substrate that is fiber-like. It is meant to include substrates having circular cross-sections, as well as those having elliptical, irregular, and rectangular cross-sections. It is also meant to include ribbon-like or strip-like substrates. These substrates may, for example, have substantially rectangular or rounded rectangular cross-sections.

The indexed positions L1, L2, L3, L4, R1, R2, R3, and R4, will be referred to herein simply as L1, L2, L3, L4, R1, R2, R3, and R4 respectively.

Reference will now be made in detail to implementations of the present invention as illustrated in the accompanying drawings. Whenever possible, the same reference numbers will be used throughout the drawings and the following description to refer to the same or like parts.

In embodiments of the present invention in which the thin-film devices are on, for example, flexible substrates and are combined into a matrix, the mechanical properties of the device may become significant when, for example, the mass ratio of the battery to substrate becomes substantial (for example, about 10% of the overall weight).

Substrates that may be used in the present invention include, for example, substrates that are cylindrical or conical; mono-filaments; fibers or fibrous substrates; wires; rods; ribbons or ribbon-like substrates; or strips or strip-like substrates. The substrates may be or include, for example, glass, ceramic, sapphire, polymer, metal, alloy, carbon, semiconductor, shape memory alloy, superconductor, or polished naturally occurring fibers. Naturally occurring fibers may include, for example, such materials as wool, cotton, hemp, or wood. These materials and shapes are exemplary only and not limiting. Other materials and shapes will be apparent to one skilled in the art, including tubular and irregular shapes.

For fibrous substrates, some preferred diameters of the substrate are between about one micron and about one-quarter inch. For substrates having rectangular shape, the length of the sides is preferably between about one micron and about five inches.

A means for deposition may be provided to deposit material onto the substrate. This means for deposition may be or include, for example, a sputter plasma (RF, AC, or DC) technique, electron beam evaporation processing, cathodic arc evaporation, chemical vapor deposition, or plasma enhanced chemical vapor deposition. Sputtering processes are a preferred technique for deposition. Sputtering may preferably be accomplished under a pressure of between approximately one and approximately twenty millitorr. A hollow cathode sputter or a cathodic arc technique may preferably be accomplished under a pressure of between approximately one tenth and approximately twenty millitorr. Preferred evaporation pressures may be between about 0.01 and about 0.1 millitorr. Preferred chemical vapor and plasma enhanced chemical vapor deposition pressures may be between about 10 millitorr and atmospheric pressure. Source powers for RF, AC, and DC sputtering may be, for example, in the approximate range of about 50 to about 300 Watts on an approximately 60 cm² target. A useful target to axis of rotation distance may be approximately 2.25 inches. Individual or multiple electron beam pocket sources, or a single linear beam evaporation trough, for example, may be utilized.

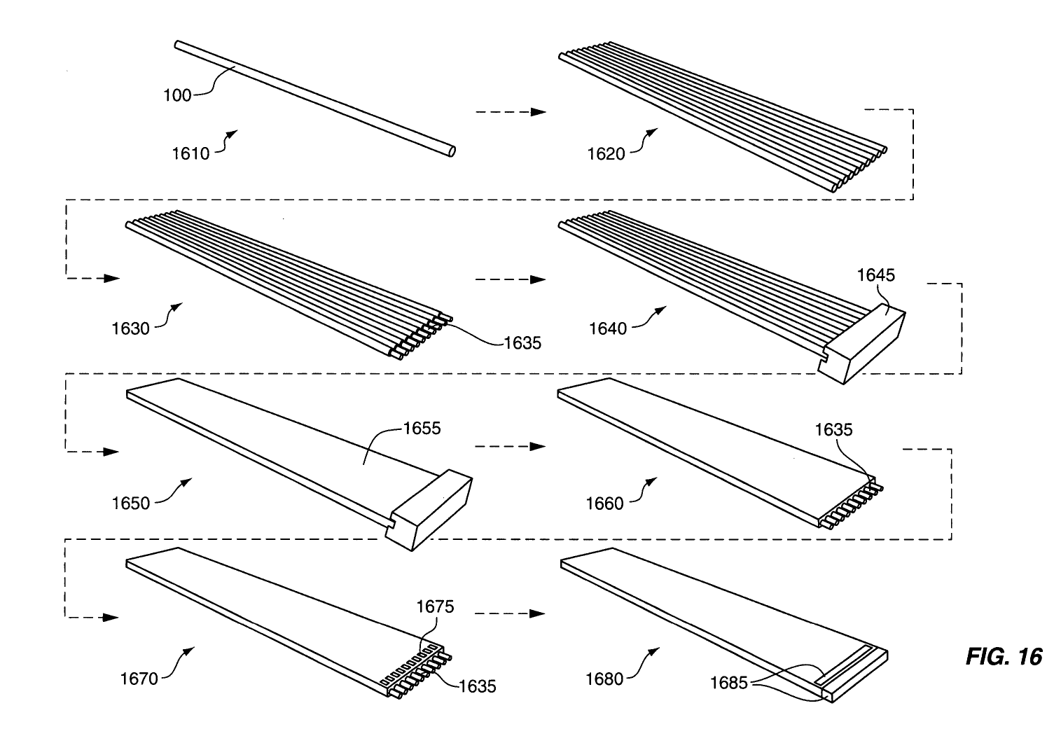

These patterns may be described in terms of a discretely indexed deposition process. Discrete indexing may not be necessary, but may provide the benefit of consistent results in output. The index used is preferably an ordinal index, based on a length-wise view of a cross section of a substrate. The index, from left to right along the length of the substrate, may start at L4 and then proceed to L3, then to L2, then to L1. These indexing positions may be followed by R1, then R2, next R3, and finally R4. An example of such an indexing system may be seen in FIG. 16. There is no requirement that there only be eight indexed positions, or that the number of indexed positions on the left and right be equal. Moreover, the difference in position between any two consecutive indexed positions may be different from the difference between the position of two other consecutive indexed positions. In a preferred embodiment, L4 is separated from L3 by about 0.25 inches, L3 is preferably separated from L2 by about 0.25 inches, and L2 is preferably separated from L1 by about 0.25 inches. In a preferred embodiment, R4 is separated from R3 by about 0.25 inches, R3 is preferably separated from R2 by about 0.25 inches, and R2 is preferably separated from R1 by about 0.25 inches. Finally, in a preferred embodiment, the distance between L1 and R1 may be between approximately 2.0 inches and approximately 7.0 inches.

In an embodiment of the present invention, the process of deposition may be applied multiple times. Between depositions, means for shadow masking, such as, for example, tubular members, may be repositioned according to an index. This indexed displacement of the tubular members may define a plurality of sequential depositions which may each have a functional pattern that may be defined by the tubular members. Additionally, the tubular members may be moved during deposition, if desired, to produce a layer with tapered thickness. Tapered or gradient thickness layer edges may also be produced by the use of a tubular member whose interior diameter has a shape that corresponds to that of the substrate plus the desired gradient. For instance, in the case of a circular substrate, the shape of the interior diameter may be conical. Movement during deposition, however, may be avoided in a preferred embodiment of the present invention.

As a result of this invention, the patterned films deposited on a substrate may include thin-film electrochemical devices such as solid-state batteries or photovoltaic cells; thin-film micro-electronic multiple interconnect devices; or other functional patterns on fibrous or ribbon-like substrates.

Additionally, the substrate may be chosen to have a complimentary or unrelated function. For example, the substrate may conduct electricity, which may be of use in certain battery or photovoltaic cell applications. Moreover, the substrate may be purely structural, possessing qualities that may only indirectly relate to the function of the device, such as rigidity, tensile strength, or ability to form a particular shape. Additionally, the substrate may perform an unrelated function, or an only distantly related function, such as, for example, an optical fiber, or a puncture resistant fiber such as, for example, a Kevlar® or Aramid® fiber. If an optical fiber is selected, it may be desirable that the deposited device may be or include, for example, a battery that may be used to boost the optical signal as needed. If a puncture resistant fiber is selected, it may be desirable that the deposited device may be or include, for example, a battery or solar power cell, and may be used as a power source for someone wearing ballistic garments. Nevertheless, while the substrate may provide multiple functions, the functions need not be related.

Additionally, in some instances, it may be beneficial to pre-sputter prior to deposition, which may result in the removal of interstitial materials and the formation of reactive surface properties on, for example, compound target surfaces. This pre-sputtering step may be accomplished by the described apparatus further including a plasma shutter means. This plasma shutter means may be or include a physical member, such as a semi-cylindrical member, which may be rotated or otherwise positioned to either shield or expose the substrate.

Additional patterning methods may be applied after deposition or between depositions. These techniques may include laser ablation or chemical or mechanical etching. Additionally, photolithographic film masking, if utilized, may involve chemical or e-beam lithographic means for removal of the photoresist after each deposition. Avoiding damage to the substrate may present some challenges in these situations.

Thin-film functional patterns, as used herein, include thin-film devices such as batteries and photovoltaic cells, and also include micro-electric circuits. Other functional patterns will be apparent to one skilled in the relevant art. Thus, the term “functional patterns” is not meant to be limited to the examples given.

Certain patterns of deposited thin films may be particularly useful in manufacturing batteries on fibrous or ribbon-like substrates. These patterns may include, for example, the Li-ion, buried Li-ion, Li-free, buried Li-free, Lithium, and buried Lithium solidstate battery configurations.

In general, a lithium-based battery deposited on a fibrous or ribbon-like substrate may include the following layers: a substrate, a metallic contact layer on the substrate, a cathode layer on the metallic contact layer, an electrolyte layer on the cathode layer, a lithium anode layer on the electrolyte layer, and an anode protectant layer on the lithium anode layer. This order may be viewed as position relative to the substrate. This particular order may describe the order in a lithium thin-film battery configuration. The positions of the lithium anode layer and cathode layer may be exchanged. The resulting configuration may be similar to the order of the buried lithium thin-film battery configuration, which is termed “buried” because the anode is “buried” beneath the electrolyte. The lithium anode layer may be replaced by some other kind of anode layer, including a Li-ion anode or a Li-free anode. These anode layers may be in either the original or “buried” order. Another way to describe buried configurations is as “inverted.” Thus, for example, a buried lithium-free configuration may also be called an inverted lithium-free configuration.

Examples of materials that may be used in a lithium ion anode include materials that form lithium alloys, such as, for example, sodium, potassium, rubidium, caesium, beryllium, magnesium, calcium, strontium, barium, boron, aluminum, gallium, indium, thallium, carbon (graphite or coke), silicon, germanium, tin, lead, phosphorus, arsenic, antimony, bismuth, selenium, or tellurium. These materials may stand alone or be combined in, for example, any binary, ternary, quaternary, pentanary, or hexanary alloy. Certain transition metals in small percentages may provide additional benefit. In a preferred embodiment the amount of transition metals may be less than approximately ten percent of the anode. Examples of transition metals include nickel, molybdenum, and gold. In addition, compounds that react partially reversibly with lithium may be used, such as SnOₓ (1≦x≦2), SnNₓ (0<x≦1.33), ZnNₓ (0<x≦1.5), CuNₓ (0<x≦1), InNₓ (0<x≦1), CuOₓ (0<x≦1), Li₄Ti₅O₁₂, and pre-lithiated forms thereof, such as Li_{y}SnNₓ (0≦x<1.33; 0<y≦8). These ranges are approximate.

Examples of materials that may be used in a Li-free anode include materials that do not form intermetallic compounds with lithium, such as, for example, Sc, Ti, V, Cr, Mn, Fe, Co, Ni, Cu, Ta, and W. These materials may stand alone or be combined in, for example, any binary, ternary, quaternary, pentanary, or hexanary alloy. Certain other metals that do not compromise the non-Li-alloying property of these alloys may provide additional benefit in small percentages. In a preferred embodiment the amount of these other metals may be less than approximately ten percent of the anode. Examples of these other metals that may be used include yttrium, zirconium, and niobium. Furthermore, non-Li-alloying compounds may also be used. Examples of non-Li-alloying compounds include, for example, TiNₓ (0<x≦1), ZrNₓ (0<x≦1), VNₓ (0<x≦1), and NbNₓ (0<x≦1). These ranges are approximate.

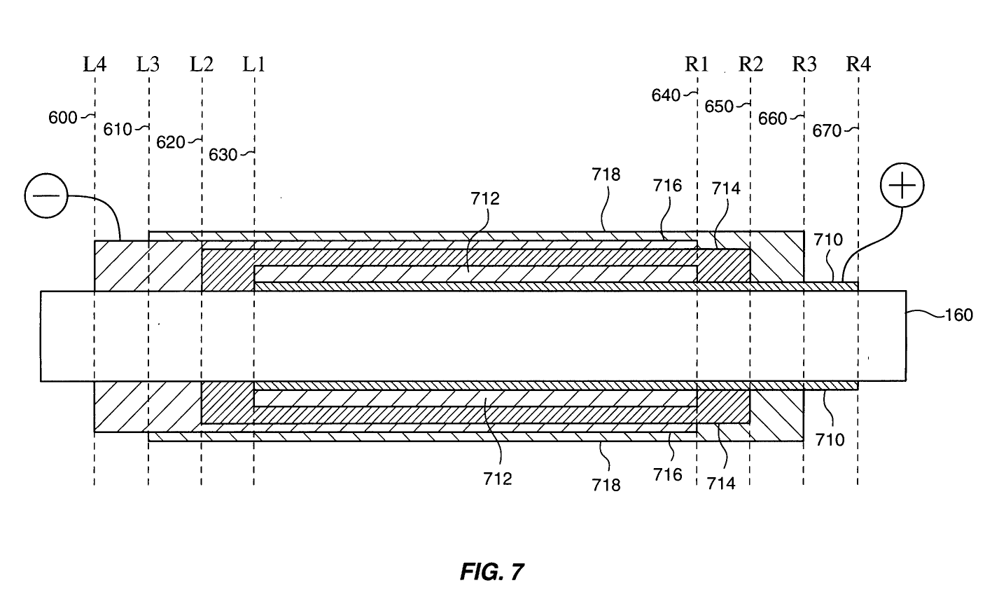

In a particular example of a lithium-free battery, the substrate may be or include, for example, an alumina fiber. The first layer to be deposited may be a cathode current collector. This cathode current collector layer may be or include, for example, chromium and may be deposited between L1 and R4. Next, the cathode layer may be deposited. The cathode layer may be or include, for example, amorphous Li_{1.6}Mn_{1.8}O₄ and may be deposited between L1 and R1. Next, the electrolyte layer may be deposited. The electrolyte layer may be or include, for example, lithium phosphorus oxynitride, otherwise and hereafter described as “Lipon,” and may be deposited between L2 and R2. Next, an electrode layer, which in this instance provides an auxiliary anode layer and anode current collector, may be deposited. The electrode layer may be or include, for example, copper, and may be deposited between L4 and R1. Next, the protectant layer may be deposited. The protectant layer may be or include, for example, Lipon, and may be deposited between L3 and R3. An example of a lithium-free configuration may be observed in FIG. 7.

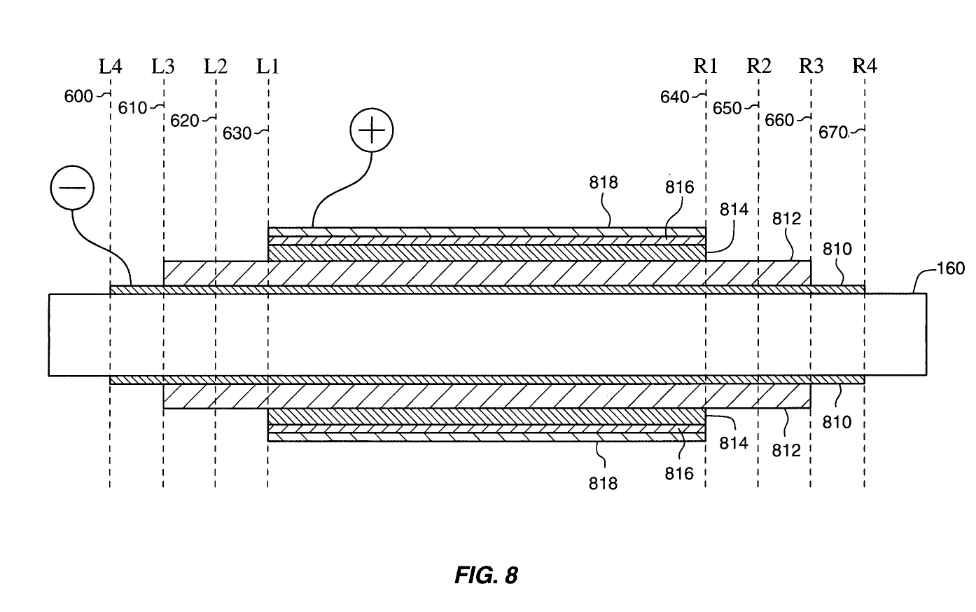

In a particular example of a buried lithium-free battery, the substrate may be or include, for example, an alumina fiber, a copper fiber, or a glass fiber. The first layer to be deposited may be an anode current collector. This anode current collector layer may be or include, for example, chromium, and may be deposited between L4 and R4. Next, the electrolyte layer may be deposited. The electrolyte layer may be or include, for example, Lipon, and may be deposited between L3 and R3. Next, the cathode layer may be deposited. The cathode layer may be or include, for example, amorphous Li_{1.6}Mn_{1.8}O₄ and may be deposited between L1 and R1. Next, an electrode layer, which may be used to provide an auxiliary cathode layer, may be deposited. The electrode layer may be or include, for example, chromium, and may be deposited between L1 and R1. Next, a cathode current collector layer may be deposited. The cathode current collector layer may be or include, for example, copper, and may be deposited between L1 and R1. An example of a buried lithium-free configuration may be observed in FIG. 8.

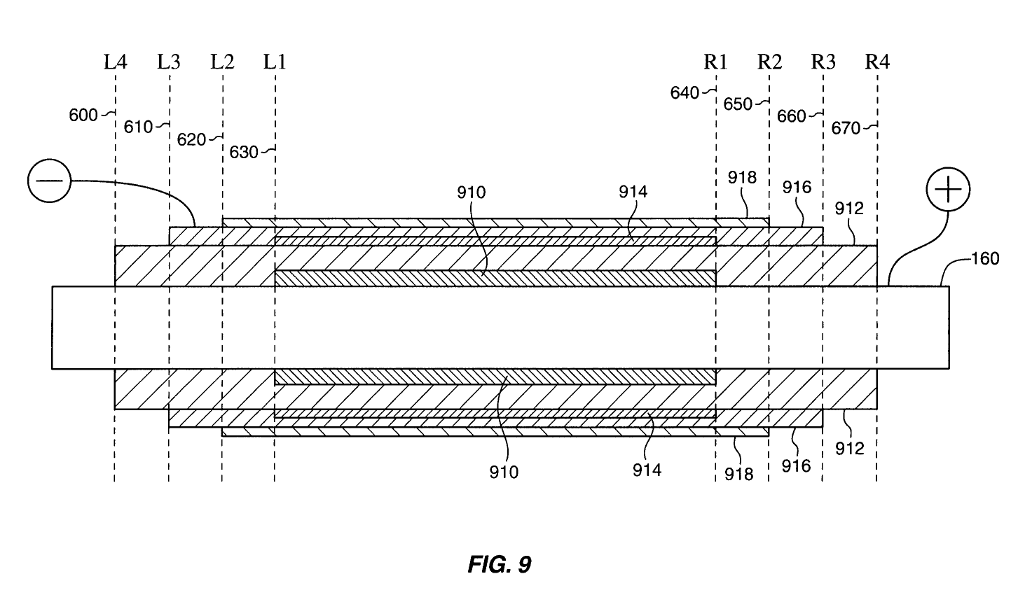

In a particular example of a lithium-ion battery, the substrate may, for example, be or include a copper fiber or an Inconel® 600 fiber. The substrate may serve as a cathode current collector. The first layer to be deposited may be a cathode layer. This cathode layer may, for example, be or include amorphous Li_{1.6}Mn_{1.8}O₄ and may be deposited between L1 and R1. Next, the electrolyte layer may be deposited. The electrolyte layer may, for example, be or include Lipon and may be deposited between L4 and R4. Next, the anode layer may be deposited. The anode layer may, for example, be or include Sn₃N₄ and may be deposited between L1 and R1. Next, an anode current collector layer may be deposited. The anode current collector layer may, for example, be or include copper and may be deposited between L3 and R3. Next, the protectant layer may be deposited. The protectant layer may, for example, be or include Lipon and may be deposited between L2 and R2. An example of a lithium-ion configuration may be observed in FIG. 9.

The thickness of the deposited films may vary according to the particular use for which the patterned thin films are desired. Desired thickness for an anode current collector may be about 0.01 to about ten microns, but may be more preferably between about 0.3 and about three microns. Desired thickness for a lithium anode may be approximately 0.01 to approximately ten microns, but may be more preferably between about one and about three microns. Desired thickness for a lithium-ion anode may be approximately 0.01 to approximately five microns, but may be more preferably between about 0.01 and about 0.3 microns. Desired thickness for an electrolyte layer may be approximately 0.05 to approximately five microns, but may be more preferably between about one and about two microns. Desired thickness for a cathode layer may be approximately 0.05 to approximately twenty microns, but may be more preferably between about 0.5 and about five microns. Desired thickness for a cathode current collector layer may be approximately 0.01 to approximately three microns, but may be more preferably between about 0.1 and about three microns. Desired thickness for an overlayer may be approximately 0.01 to approximately ten microns, but may be more preferably between about 0.1 and about three microns. Desired thickness for a final encapsulation layer may be approximately 0.01 to approximately twenty microns, but may be more preferably between about one and about ten microns.

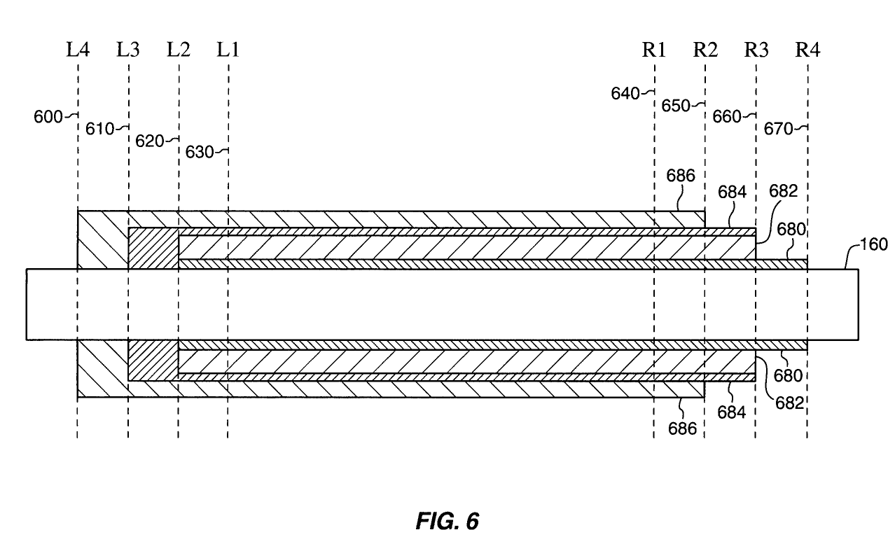

A particular example of a functional pattern may be a copper-indium-gallium-selenide (CIGS) photovoltaic device configuration. At its core may be, for example, an approximately 100 micron insulating fiber. On the fiber and between L1 and R4 may be, for example, an approximately 0.5 micron bottom cell contact layer of molybdenum. On the molybdenum layer and between L1 and R3 may be, for example, an approximately 2.0 micron layer of p-type absorber, such as, for example, a copper-indium-gallium-selenide device. On the p-type absorber layer and between L2 and R3 may be, for example, an approximately 0.05 micron layer of CdS. On the CdS layer and between L4 and R2 may be, for example, an approximately 0.6 micron top cell contact layer of transparent conductive oxide, such as, for example, indium-tin oxide. An example of CIGS photovoltaic device configuration may be observed in FIG. 6.

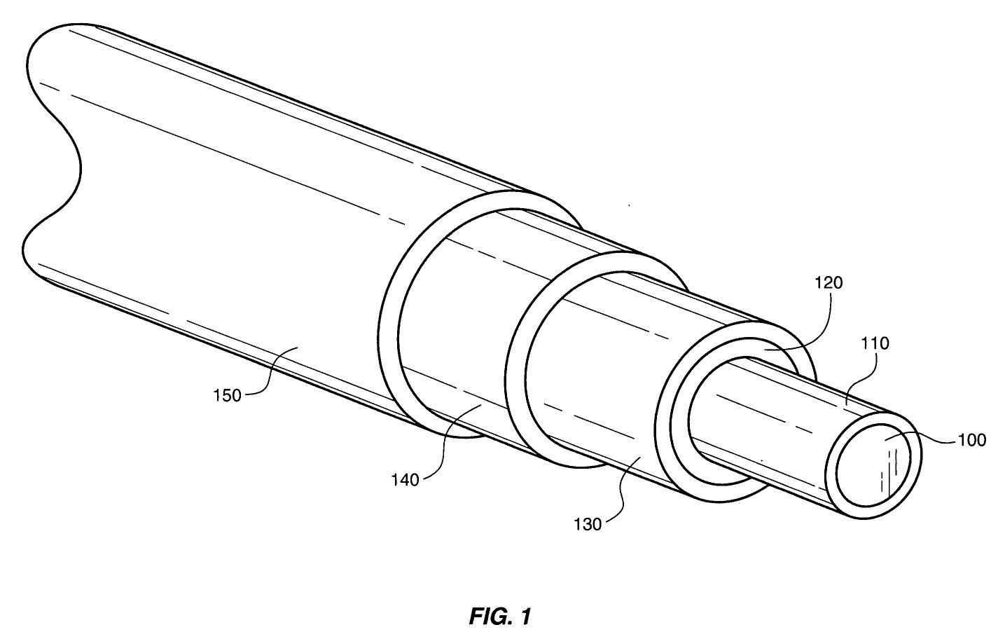

FIG. 1 is a perspective view cut-away diagram of an embodiment of a thin-film lithium battery on a substrate 100, which may be a fibrous substrate as shown here. FIG. 1 demonstrates the concept of using a solid-state thin-film battery on, for example, a fibrous substrate. For example, the anode protectant layer 150 (or encapsulation layer) may be or include an overlayer, a multilayer of parylene and aluminum or titanium, or a multilayer of polyacrylates and inorganic layers. More specifically, the drawing depicts a lithium thin-film battery configuration that may use a metallic lithium anode 140 on the outer side of the electrolyte 130. The use, in this example, of a metallic contact layer 110, may permit the substrate to be a non-conducting or poorly conducting material, such as, for example, glass or plastic. By interchanging the position of the lithium anode 140 and the cathode 120, one may obtain a buried lithium thin-film battery configuration. By replacing the lithium anode 140 by a lithium ion anode, one may obtain a lithium-ion thin-film battery configuration. A lithium ion anode may include materials that form lithium alloys, such as, for example, sodium, potassium, rubidium, caesium, beryllium, magnesium, calcium, strontium, barium, boron, aluminum, gallium, indium, thallium, carbon (graphite or coke), silicon, germanium, tin, lead, phosphorus, arsenic, antimony, bismuth, selenium, or tellurium. These materials may stand alone or be combined in, for example, any binary, ternary, quaternary, pentanary, or hexanary alloy. Certain transition metals in small percentages may provide additional benefit. In a preferred embodiment the amount of transition metals may be less than approximately ten percent of the anode. Examples of transition metals include Ni, Mo, and Au. In addition, compounds that react partially reversibly with lithium may be used, such as SnOₓ (1≦x≦2), SnNₓ (0<x≦1.33), ZnNₓ (0<x≦1.5), CuNₓ (0<x≦1), InNₓ (0<x≦1), CuOₓ (0<x≦1), Li₄Ti₅O₁₂, and pre-lithiated forms thereof, such as Li_{y}SnNₓ (0<xₓ1.33; 0<y≦8). These ranges are approximate. By interchanging the position of the lithium-ion anode and the cathode 120, one may obtain a buried lithium-ion thin-film battery configuration. By replacing the lithium anode 140 by an electrically conducting anode that does not form intermetallic compounds with lithium, one may obtain a lithium-free thin-film battery configuration. Examples of materials that may be used in a lithium-free configuration include materials that do not form intermetallic compounds with lithium, such as, for example, Sc, Ti, V, Cr, Mn, Fe, Co, Ni, Cu, Ta, and W. These materials may stand alone or be combined in, for example, any binary, ternary, quaternary, pentanary, or hexanary alloy. Certain other metals that do not compromise the non-Li-alloying property of these alloys may provide additional benefit in small percentages. In a preferred embodiment the amount of these other metals may be less than approximately ten percent of the anode. Examples of these other metals that may be used include Y, Zr, and Nb. Furthermore, non-Li-alloying compounds may also be used. Examples of non-Li-alloying compounds include, for example, TiNₓ (0<x≦1), ZrNₓ (0<x≦1), VNₓ (0<x≦1), and NbNₓ (0<x≦1). These ranges are approximate. By interchanging the position of the cathode 120 and the electrically conducting anode that does not form intermetallic compounds with lithium, one may obtain a buried lithium-free thin-film battery configuration.

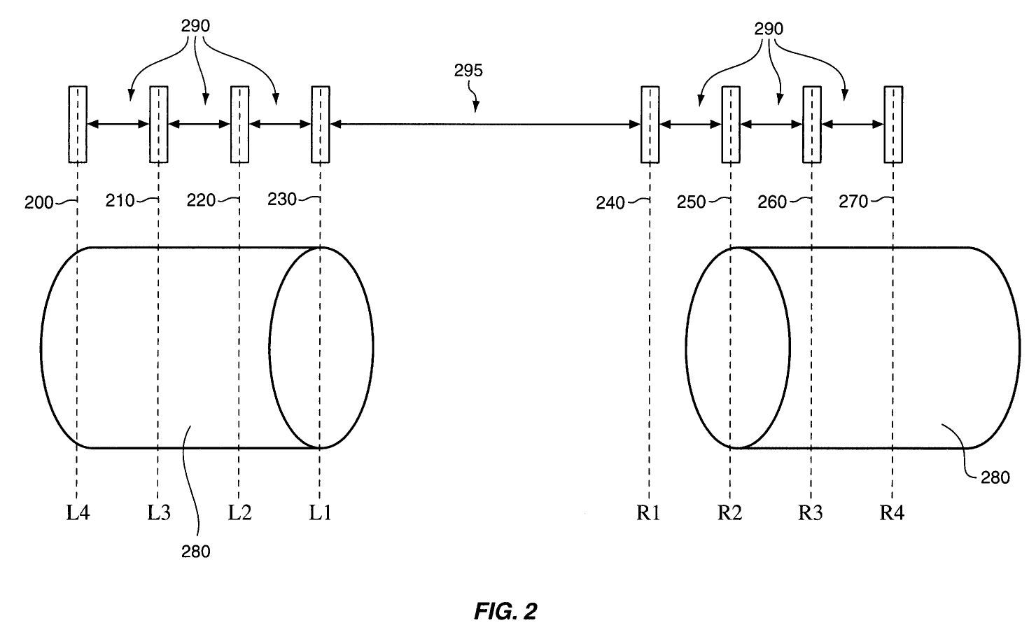

FIG. 2 is a stylized depiction of the operation of a discrete deposition indexing method. In this example, eight positions are indexed (L1 230, L2 220, L3 210, L4 200, R1 240, R2 250, R3 260, R4 270); however, this number of positions, although convenient in a preferred embodiment of the present invention are merely an example. Additionally, the provided spacings 290, 295 are exemplary only, and may be tailored as desired. In one embodiment of the present invention spacing 290 may be about 0.25 inches and spacing 295 may be approximately 5.0 inches. In particular, the spacing 295 between L1 230 and R1 240 may generally dominate and determine the overall length of the functional pattern. The tubular members 280 (which may be referred to as cylindrical members) shown are representations of a pair of tubular members 280 in the indexed positions L1 230 and R2 250 respectively. In this diagram, the substrate 100 is not shown.

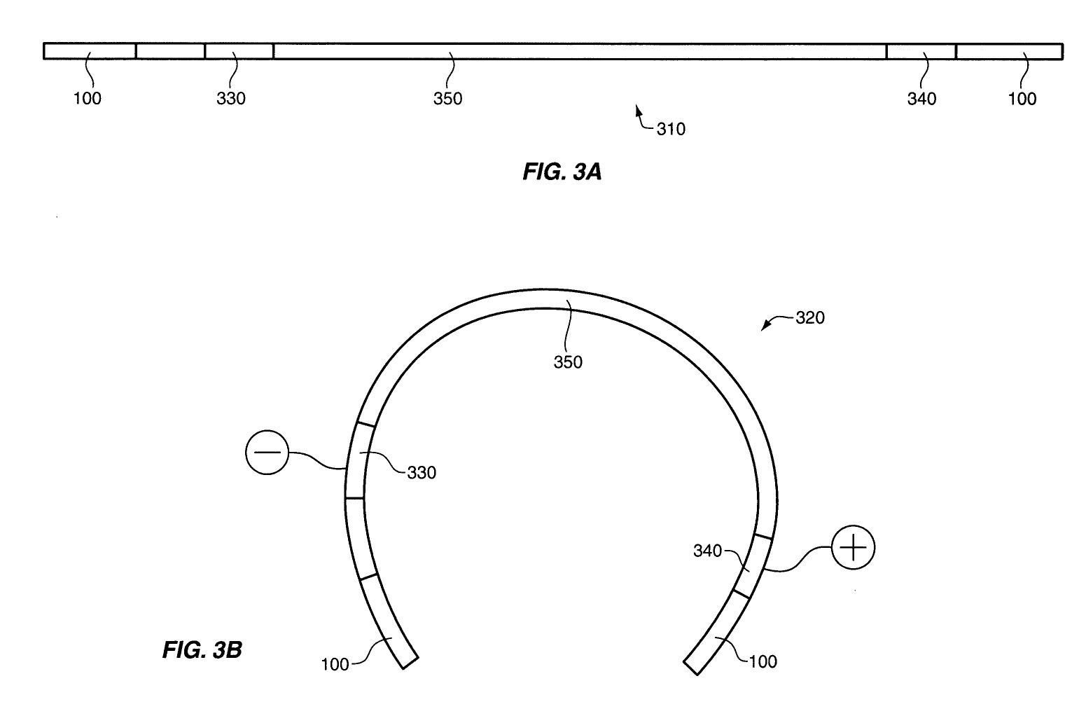

FIGS. 3A and 3B depict a pair of side views of a solid-state thin-film battery 350 in an unflexed 310 and flexed 320 position respectively. The solid-state thin-film battery may be flexed 320 as shown, and while flexed, electrical leads may be connected to its terminals 330, 340. The battery may be maintained in a flexed position by physically restraining the exposed portion of the substrate 100. A battery may be used in the positions shown.

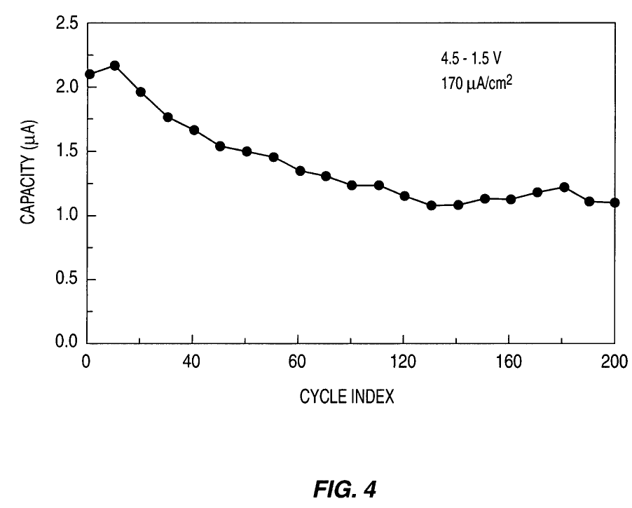

FIG. 4 depicts the capacity measured in microampere-hours of a battery manufactured according to the present invention over 200 power cycles. In this test embodiment, the battery from which these test results were taken consisted of a 12.7 cm long lithium-free battery deposited on a 150 micron alumina fiber substrate. The cathode current collector was 0.3 microns thick, the cathode layer was 1.4 micron thick, the Lipon electrolyte layer was 1.5 microns thick, and the copper electrode was 2 microns thick. Finally, the protective Lipon coating was 1 micron thick.

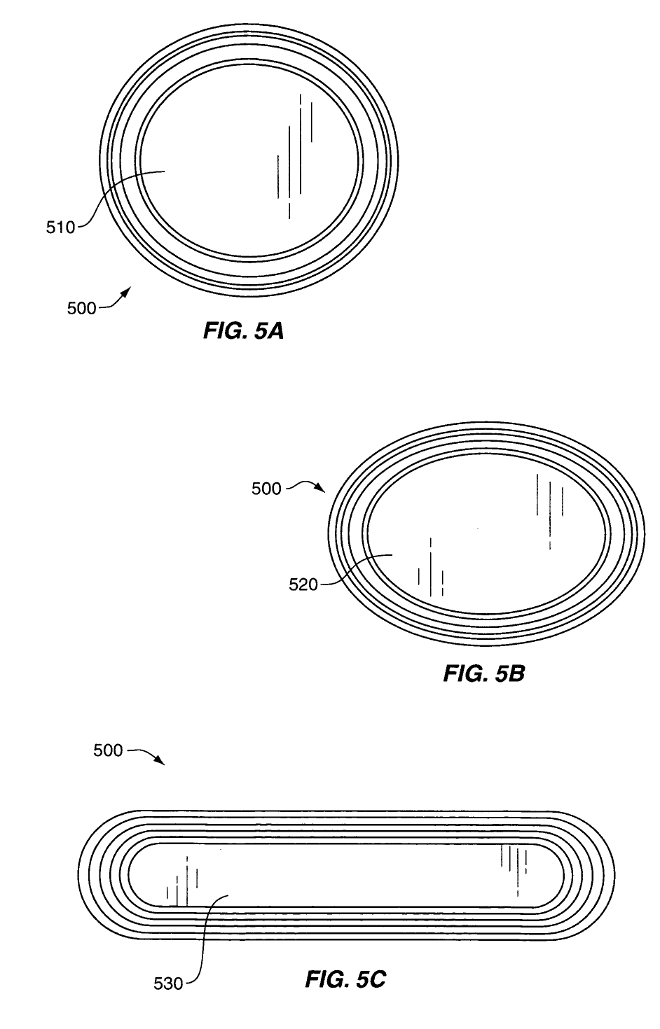

FIGS. 5A, 5B, and 5C are cross-sectional views of several embodiments of the present invention and show cross-sections of a solid-state thin-film battery 500 on a fibrous substrate 510, an ellipsoidal substrate 520, which may be viewed as an anisotropically compressed fibrous substrate, and a ribbon-like or strip-like substrate 530. The close relationship of the fibrous 510 and ribbon-like or strip-like 530 geometry may be apparent upon examination. Hence, ribbon-like and strip-like substrates 530 may be considered deformations of fibrous substrates 510 or vice versa.

FIG. 6 is a length-wise cutaway diagram of a CIGS photovoltaic device configuration. At its core may be, for example, a 100 micron insulating fiber, which serves as the substrate 160. On the substrate 160 and between L2 620 and R4 670 may be, for example, a 0.5 micron bottom cell contact layer of molybdenum 680. On the molybdenum layer 680 and between L2 620 and R3 660 may be, for example, a 2.0 micron layer of p-type absorber 682, such as, for example, a CIGS. On the p-type absorber layer 682 and between L3 610 and R3 660 may be, for example, a 0.05 micron layer of CdS 684. On the CdS layer 684 and between L4 600 and R2 650 may be, for example, a 0.6 micron top cell contact layer of transparent conductive oxide 686, such as, for example, indium-tin oxide. In this diagram, the axis of the substrate 160, extends from left to right across the page.

FIG. 7 is a length-wise cutaway diagram of a lithium-free battery configuration. At its core may be, for example, a 150 micron alumina fiber, which serves as a substrate 160. On the substrate 160 and between L1 630 and R4 670 may be, for example, a 0.3 micron layer of chromium 710. On the chromium layer 710 and between L1 630 and R1 640 may be, for example, a 1.4 micron layer of Li_{1.6}Mn_{1.8}O₄ 712. On the Li_{1.6}Mn_{1.8}O₄ layer 712 and between L2 620 and R2 650 may be, for example, a 1.5 micron layer of Lipon 714. On the Lipon layer 714 and between L4 600 and R1 640 may be, for example, a 2.0 micron layer of copper 716. On the copper layer 716 and between L3 610 and R3 660 may be, for example, a 0.3 micron layer of Lipon 718. In this diagram, the axis of the substrate 160, extends from left to right across the page.

FIG. 8 is a length-wise cutaway diagram of a buried lithium-free battery configuration. At its core may be, for example, a 150 micron alumina fiber, a 100 micron copper fiber, a 100 micron glass fiber, or a 150 micron sapphire fiber; this fiber may serve as a substrate 160. On the substrate 160 and between L4 600 and R4 670 may be, for example, a 1.0 micron layer of chromium 810. On the chromium layer 810 and between L3 610 and R3 660 may be, for example, a 2.0 micron layer of Lipon 812. On the Lipon layer 812 and between L1 630 and R1 640 may be, for example, a 1.0 micron layer of Li_{1.6}Mn_{1.8}O₄ 814. On the Li_{1.6}Mn_{1.8}O₄ layer 814 and between L1 630 and R1 640 may be, for example, a 0.5 micron layer of chromium 816. On the chromium layer 816 and between L1 630 and R1 640 may be, for example, a 0.5 micron layer of copper 818. In this diagram, the axis of the substrate 160, extends from left to right across the page.

FIG. 9 is a length-wise cutaway diagram of a lithium-ion battery configuration. At its core may be, for example, a 100 micron copper or Inconel® 600 fiber, which may serve as a substrate 160. On the substrate 160 and between L1 630 and R1 640 may be, for example, a 1.0 micron layer of Li_{1.6}Mn_{1.8}O₄ 910. On the Li_{1.6}Mn_{1.8}O₄ layer 910 and between L4 600 and R4 670 may be for example, a 2.0 micron layer of Lipon 912. On the Lipon layer 912 and between L1 630 and R1 640 may be, for example, a 0.1 micron layer of Sn₃N₄ 914. On the Sn₃N₄ layer 914 and between L3 610 and R3 660 may be, for example, a 0.2 micron layer of copper 916. On the copper layer 916 and between L2 620 and R2 650 may be, for example, a 0.2 micron layer of Lipon 918. In this diagram, the axis of the substrate 160, extends from left to right across the page.

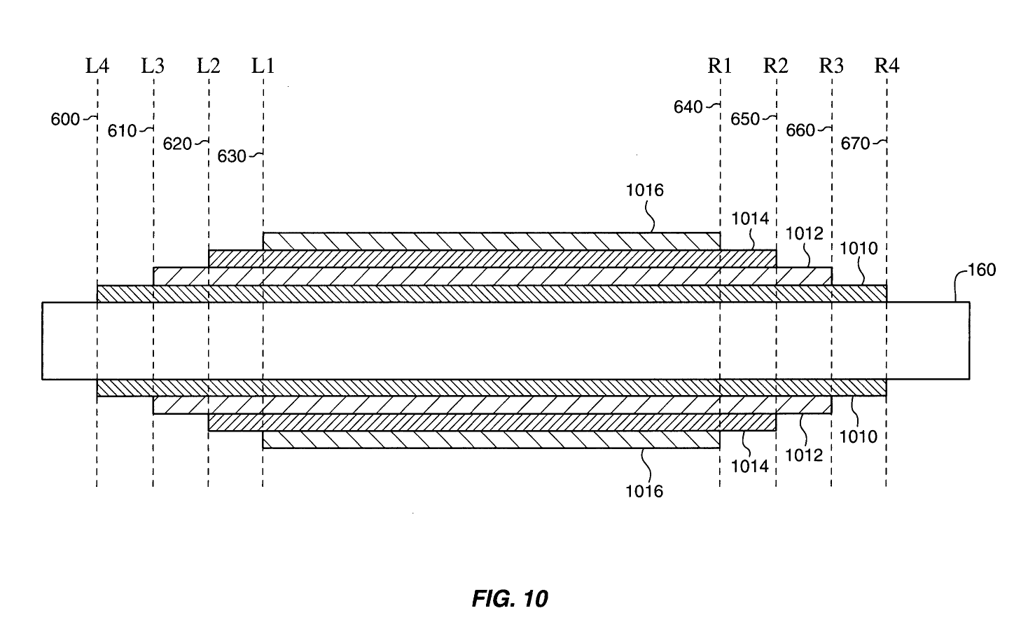

FIG. 10 is a length-wise cutaway diagram of a micro-electronic interconnect configuration. At its core may be an insulating or conducting fiber, which may serve as a substrate 160. On the fiber and between L4 600 and R4 670 there may be, for example, an approximately 2.0 micron layer of insulator 1010. On this insulator layer 1010 and between L3 610 and R3 660 may be an approximately 1.0 micron layer of conductor 1012. On this layer of conductor 1012 and between L2 620 and R2 650 may be, for example, an approximately 2.0 micron layer of insulator 1014. On this layer of insulator 1014 and between L1 630 and R1 640 may be, for example, an approximately 1.0 micron layer of conductor.

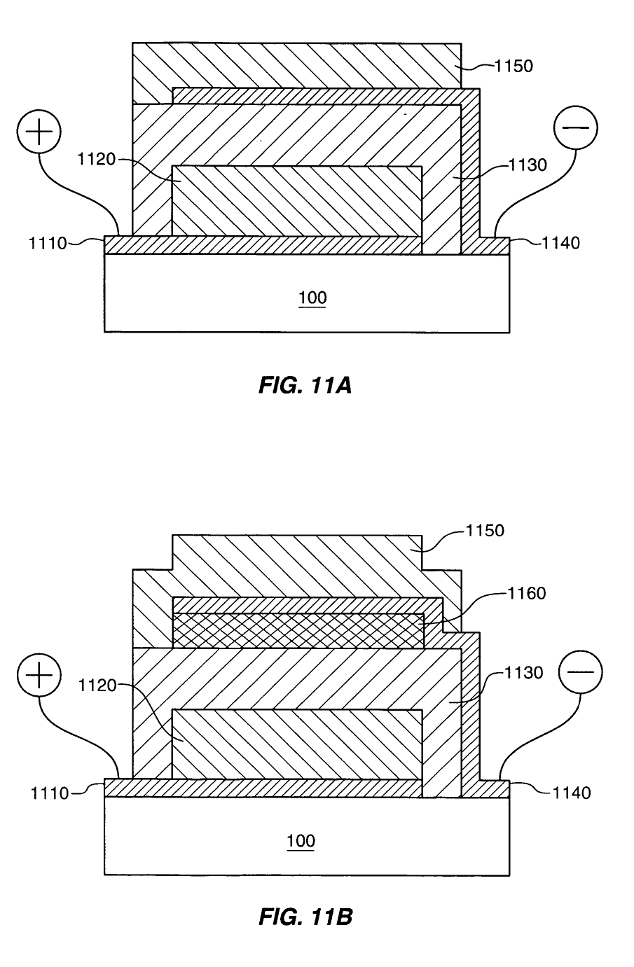

FIGS. 11A and 11B are two stages of a working mechanism diagram of a lithium-free battery configuration. The battery includes, for example, a substrate 100, a cathode current collector 1110 (“ccc”), a cathode 1120, an electrolyte 1130 (such as Lipon), an anode current collector 1140 (“acc”), and an overlayer 1150. FIG. 11A shows a fully discharged battery whereas FIG. 11B depicts a battery charged to some degree. In a preferred embodiment, sputter depositing a metallic acc 1140 relatively thickly (about 0.5 to about 10 μm) yields a very porous morphology of the acc 1140. This porous morphology may be beneficial in reducing the build-up of stress associated with the creation of new volume when a lithium anode 1160 is plated during charge between an overlayer 1150 and an electrolyte 1130. Reducing the build-up of stress during cycling of thin-film batteries may incur the benefit of increased cycle life and performance reliability.

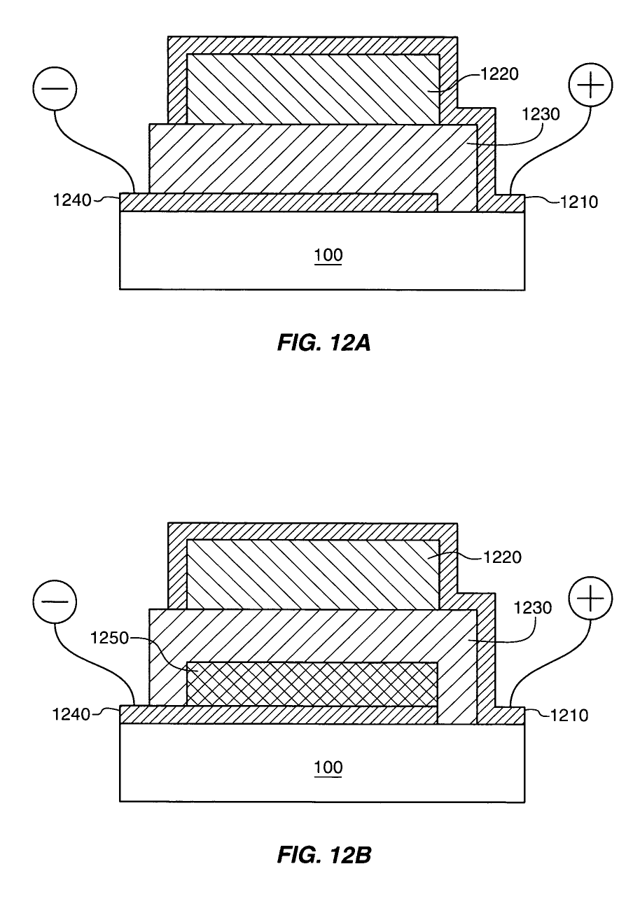

FIGS. 12A and 12B are two stages of a working mechanism diagram of a buried lithium-free battery configuration. The battery includes, for example, a substrate 100, a ccc 1210, a cathode 1220, an electrolyte 1230, an acc 1240, and an overlayer (optional—not shown). This battery working mechanism may appear to be very similar to the mechanism depicted in FIGS. 11A-B. A primary difference between the battery configurations of FIGS. 11A-B and 12A-B may relate to the sequential deposition of the individual layers and the buried geometry that automatically protects the potentially very air-sensitive plated lithium anode 1250 without requiring the deposition of an extra overlayer as seen, for example, in FIGS. 11A-B. FIG. 12A shows a fully discharged battery while FIG. 12B depicts a battery charged to some degree.

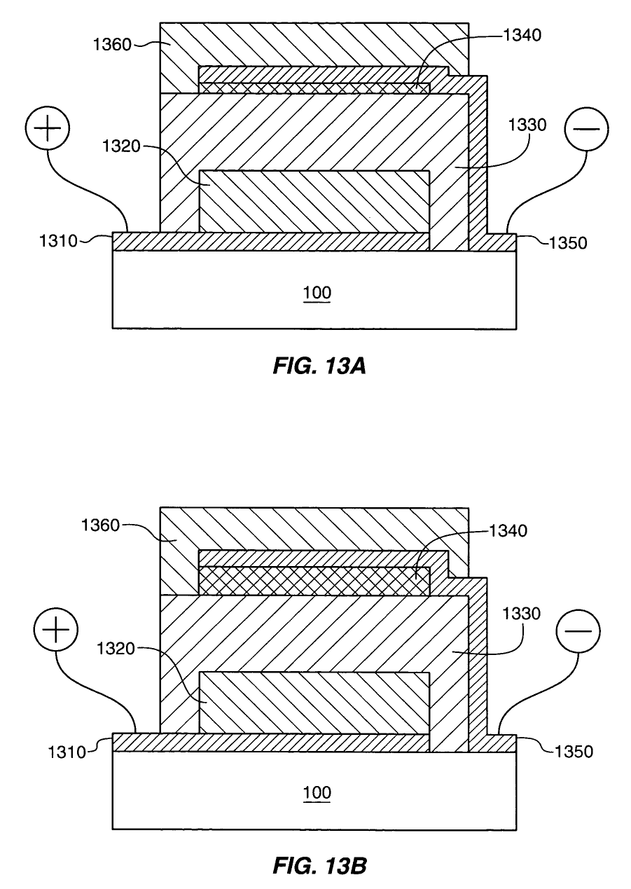

FIGS. 13A and 13B are two stages of a working mechanism diagram of a lithium-ion battery configuration. The battery includes, in this instance, a substrate 100, a ccc 1310, a cathode 1320, an electrolyte 1330, an anode 1340, an acc 1350, and an overlayer 1360 (optional—shown here). FIG. 13A shows a fully discharged battery while FIG. 13B depicts a battery charged to some degree.

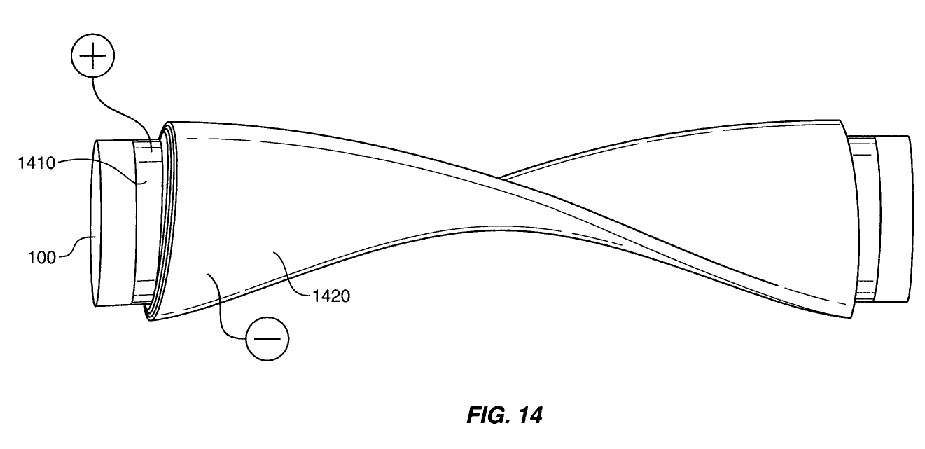

FIG. 14 is a side view of a twisted embodiment of the present invention employing a single device on a substrate 100. In one embodiment, the layer closest to the substrate 100 may serve as a ccc 1410, while the outermost layer may serve as an acc 1420.

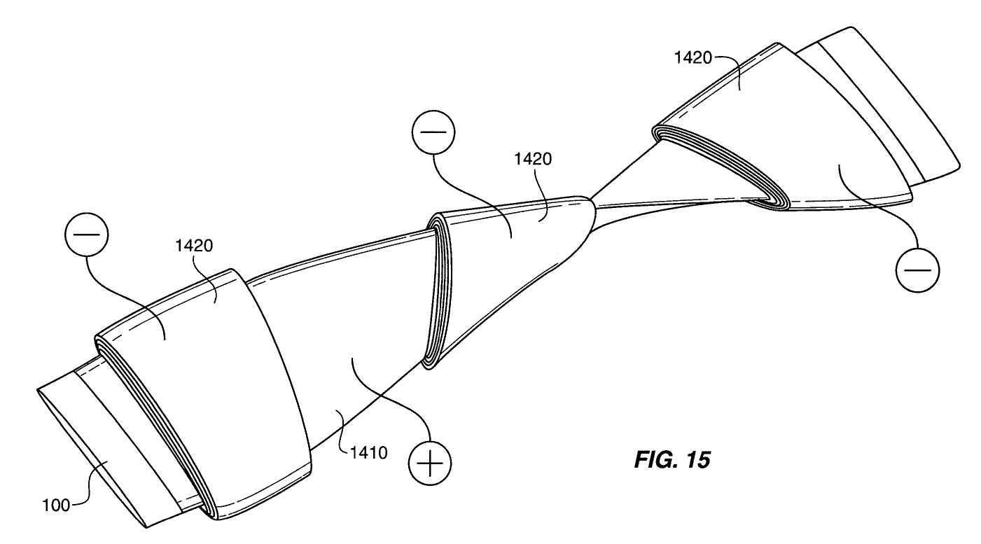

FIG. 15 is a perspective view of a twisted embodiment of the present invention employing three devices on a single substrate 100. As in FIG. 14, in one embodiment, the layer closest to the substrate may serve as a ccc 1410, while the outermost layer may serve as an acc 1420.

FIG. 16 is a depiction of multiple embodiments of the present invention connected together. FIG. 16 shows one embodiment for electrically connecting a plurality of substrates 100 that have one or more batteries on each substrate 100, to one another, thereby increasing the overall capacity or the overall voltage or both. In frame 1610, a single substrate 100 with deposited functional pattern is shown. In frame 1620, several individual substrates 100 are shown laid parallel to one another. Frame 1630 shows the substrates with an electrical contact layer 1635 exposed. The electrical contact layer 1635 may be exposed by, for example, etching the substrates 100. In frame 1640, a protective clamp 1645 is placed over the exposed electrical contact layer 1635. In frame 1650, a matrix 1655 may be added to maintain, for example, the relative position of the substrates 100, or, for another example, to facilitate ease of handling. In frame 1660, the protective clamp 1645 may be removed from the electrical contact layer 1635. In frame 1670, additional electrical contacts 1675 may be exposed as needed. These contacts may, for example, be exposed by a scribing process. Finally, in frame 1680, leads 1685 may be connected to the previously exposed electrical contacts.

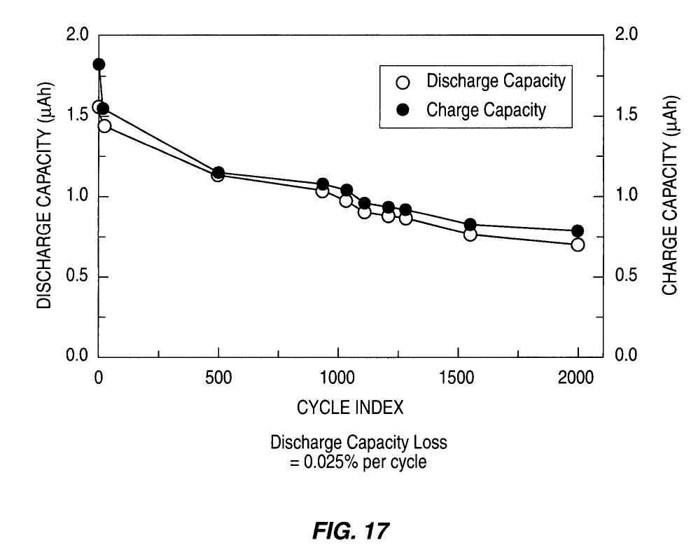

FIG. 17 is a diagram of the performance of an embodiment of the present invention in terms of discharge capacity in microampere-hours with respect to number of charge-discharge cycles. This depicted performance data is based on an example embodiment of the present invention that includes a composite of eight electrically parallel connected batteries on fibrous substrates. Each battery, in this example, has the battery configuration of a 150 μm inch diameter SiC fiber substrate, a 0.9 μm Cu inverted (buried) Li-free anode current collector layer, a 0.7 μm Lipon electrolyte layer, a 0.05 μm SnNₓ-Lipon absorption interlayer, a 0.8 μm Lipon electrolyte layer, a 0.4 μm Li₂V₂O₅ cathode/0.4 μm Cu cathode current collector layer, and a 0.4 μm Lipon protective overlayer. The cathode layer, in this example, extends about 5 cm. The total cross-sectional area for each battery, in this example, is approximately 0.24 cm². This figure demonstrates that, if an embodiment of the present invention survives cycling for more than about 10 cycles without breaking or leaking, it is very unlikely to develop a leak later. In other words, this embodiment of the present invention has very good cycle stability. The plot shows this exceptionally high cycle stability (small capacity loss per cycle) in addition to the remarkable achievement of reaching 2000 cycles.

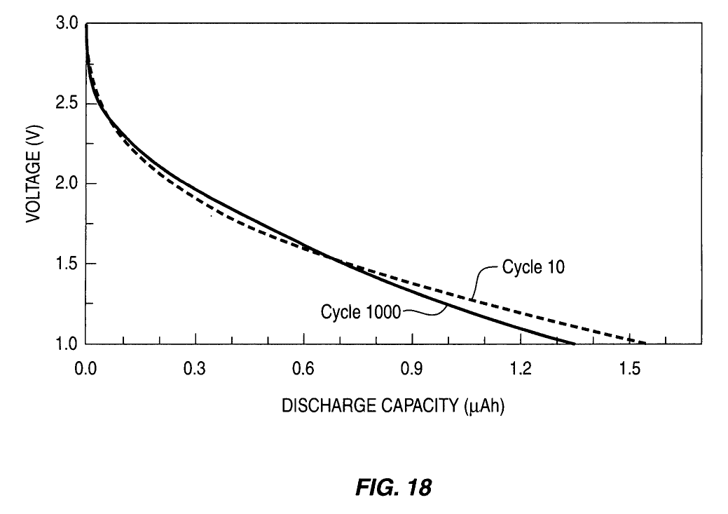

FIG. 18 is a diagram of the performance of an embodiment of the present invention in terms of voltage with respect to discharge capacity measured in microampere-hours. This depicted performance data is based on an example embodiment of the present invention that includes a composite of eight electrically parallel connected batteries on fibrous substrates. Each battery, in this example, has the battery configuration of a 150 μm inch diameter SiC fiber substrate, a 0.9 μm Cu inverted (buried) Li-free anode current collector layer, a 0.7 μm Lipon electrolyte layer, a 0.05 μm SnNₓ-Lipon absorption interlayer, a 0.8 μm Lipon electrolyte layer, a 0.4 μm Li₂V₂O₅ cathode/0.4 μm Cu cathode current collector layer, and a 0.4 μm Lipon protective overlayer. The cathode layer, in this example, extends about 5 cm. The total cross-sectional area for each battery, in this example, is approximately 0.24 cm². This plot displays the pertinent discharge voltage profile between 3.0-1.0 V as a function of discharge capacity. The measurements were taken at cycles 10 and 1000 as shown. The almost identical shapes of these voltage profiles illustrates that this embodiment of the present invention configured in an inverted Li-free battery configuration and a Li₂V₂O₅ cathode undergoes only marginal changes during the course of 990 cycles.

Other embodiments of the invention will be apparent to those skilled in the art from consideration of the specification and the practice of the invention disclosed herein. It is intended that the specification and examples be considered as exemplary only, with the true scope and spirit of the invention being indicated by the following claims.

1. A method for depositing patterned thin films comprising the steps of:
providing a fibrous substrate;
depositing a plurality of functional layers on portions of said substrate; and
defining said portions in accordance with a function of said functional layer.

2. The method of claim 1 wherein one or more of said functional layers comprises a layer selected from a group consisting of:
an anode current collector layer; an anode layer; an electrolyte layer; a cathode layer; a cathode current collector layer; an overlayer; a photoactive layer; an n-type window layer; a p-type absorber layer; a transparent conductive layer; an electrically conductive layer; a metallic layer; a semiconductor layer; an optically transmissive layer; a thermally insulating layer; a thermally conductive layer; a weatherproofing layer; a cell contact layer; a via layer; a bus layer; a printed circuit layer; a sheath layer; a lubricating layer; a colored layer; a grip layer; a buffer layer; and an auxiliary layer.

3. The method of claim 1, wherein said functional layers are arranged in an exposed anode battery configuration.

4. The method of claim 1, wherein said functional layers are arranged in a buried anode battery configuration.

5. The method of claim 1, wherein said functional layers are arranged in a lithium-based battery configuration.

6. The method of claim 1, wherein said functional layers are arranged in a lithium-ion based battery configuration.

7. The method of claim 1, wherein said functional layers are arranged in a lithium-free battery configuration.

8. The method of claim 1, wherein said functional layers are arranged in a sodium based battery configuration.

9. The method of claim 1, wherein said functional layers are arranged in a proton based battery configuration.

10. The method of claim 1, wherein said step of depositing a plurality of functional layers on portions of said substrate comprises a shadow masking technique.

11. The method of claim 1, wherein said step of defining said portions in accordance with a function of said functional layer comprises a shadow masking technique.

12. The method of claim 1, further comprising applying one or more functional layers to said substrate by means of a shadow masking technique.

13. A method for depositing electrochemical layers comprising the steps of:
providing a substrate; and
forming a plurality of electrochemical layers on selected portions of said substrate, wherein said forming provides at least a cathode layer and an electrolyte layer, and wherein said electrolyte layer is provided between said cathode layer and said substrate.

14. The method of claim 13, wherein said electrochemical layers comprise an anode current collector layer on said substrate, an electrolyte layer on said anode current collector layer, a cathode layer on said electrolyte layer, and a cathode current collector layer on said cathode layer.

15. The method of claim 14, further comprising providing an anode layer between said anode current collector layer and said electrolyte layer.

16. The method of claim 15, wherein said anode layer comprises a layer selected from a group consisting of a lithium metal anode layer and a lithium-ion anode layer.
